(19) United States
(12) Patent Application Publication
(10) Pub. No.: US 2024/0198471 A1
(43) Pub. Date: Jun. 20, 2024

(54) MACHINE TOOL DIAGNOSIS SYSTEM AND DIAGNOSIS METHOD

(71) Applicant: Industrial Technology Research Institute, Chutung (TW)

(72) Inventors: Chi-Chen LIN, Chutung (TW); Chun-Yu TSAI, Chutung (TW); Chia-Chin CHUANG, Chutung (TW); Shao-Ku HUANG, Chutung (TW)

(21) Appl. No.: 18/180,673

(22) Filed: Mar. 8, 2023

(30) Foreign Application Priority Data
Dec. 16, 2022 (TW) 111148604

(51) Int. Cl. B23Q 17/09; B23Q 17/20

(52) U.S. Cl. CPC B23Q 17/0904; B23Q 17/0952; B23Q 17/20

(57) ABSTRACT

A machine tool diagnosis method is operated in conjunction with a machine tool diagnosis system, which uses a convolutional neural network (CNN) model to analyze machining signals to generate target information including processing results and diagnosis opinions, and graphically displays a machining path of a target machining object on a display interface according to the processing results, where the display interface will further display the diagnosis opinions corresponding to the machining path.

### BACKGROUND

### 1. Technical Field

The present disclosure relates to a tool diagnosis mechanism, and more particularly, to a machine tool diagnosis system and diagnosis method.

### 2. Description of Related Art

With the rapid development of machine tool automation, it has become the mainstream to use the input of relevant parameters to carry out relevant machining operations. Therefore, currently machine tools have widely used computer numerical control (CNC) for machining operations.

Furthermore, with the development of advanced manufacturing technology, higher requirements are placed on the stability and reliability of cutting machining operations. In the actual cutting machining operations, tools failure often affects the efficiency, precision, quality, stability and reliability of the cutting machining operations, so selecting appropriate cutting parameters during the cutting machining operations is extremely important to improve the machining accuracy and quality.

In the conventional cutting machining operation, the operator needs to carry out the product proofing operation first, and often uses his or her own experience to plan the adjustment parameters. However, as machining conditions become more complex and machining quality requirements increase, operator can no longer effectively adjust machines or face other emergencies based on experience alone. Therefore, it takes a lot of time to test parameters and engineering methods, resulting in a significant increase in production costs.

Therefore, how to overcome the deficiency of the above-mentioned conventional technology has become a difficult problem urgently to be overcome in the industry.

### SUMMARY

The present disclosure provides a machine tool diagnosis method for applying to a machine tool configured with a controller and a main shaft, the machine tool diagnosis method comprising: acquiring a plurality of machining signals of the controller and the main shaft when the machine tool processes a target machining object; processing the plurality of machining signals via a target module to obtain target information, wherein the target information includes processing results and diagnosis opinions: graphically presenting a machining path of the target machining object on a display interface according to the processing results: and displaying the diagnosis opinions corresponding to the machining path by the display interface.

The present disclosure further provides a machine tool diagnosis system for applying to a machine tool configured with a controller and a main shaft, the machine tool being used to process a target machining object, the machine tool diagnosis system comprising: an acquisition module configured for acquiring a plurality of machining signals of the controller and the main shaft: an analysis module communicatively connected to the acquisition module to receive and process the plurality of machining signals, wherein the analysis module includes a target module for processing the plurality of machining signals to obtain target information, and the target information includes processing results and diagnosis opinions: and an interaction module communicatively connected to the analysis module to graphically present a machining path of the target machining object on a display interface according to the processing results, wherein the display interface further displays the diagnosis opinions corresponding to the machining path.

### BRIEF DESCRIPTION OF THE DRAWINGS

FIG. 1 is a schematic configuration diagram of a machine tool diagnosis system according to the present disclosure.

FIG. 2A is a schematic diagram illustrating a process of generating target information of the machine tool diagnosis system according to the present disclosure.

FIG. 2B is a schematic diagram illustrating a construction process of a target module of the machine tool diagnosis system according to the present disclosure.

FIG. 2C is a schematic diagram of a screen of an interaction module of the machine tool diagnosis system according to the present disclosure on a display interface.

FIG. 3 is a flowchart illustrating a machine tool diagnosis method according to the present disclosure.

FIG. 4A to FIG. 4B are schematic diagrams illustrating an interaction process on a display interface of the machine tool diagnosis method according to the present disclosure.

### DETAILED DESCRIPTIONS

The following describes the implementation of the present disclosure with examples. Those familiar with the art can easily understand the other advantages and effects of the present disclosure from the content disclosed in this specification. It should be understood that, the structures, ratios, sizes, and the like in the accompanying figures are used to illustrate the content disclosed in the present disclosure for one skilled in the art to read and understand, rather than to limit the conditions for practicing the present disclosure. Any modification of the structure, alteration of the ratio relationship, or adjustment of the size without affecting the possible effects and achievable proposes should still fall in the range compressed by the technical content disclosed in the present disclosure. Meanwhile, terms such as “on,” “first,” “second,” “one” and the like used herein are merely used for clear explanation rather than limiting practical range by the present disclosure, and thus, the alteration or adjustment of relative relationship thereof without altering the technical content should be considered in the practical scope of the present disclosure.

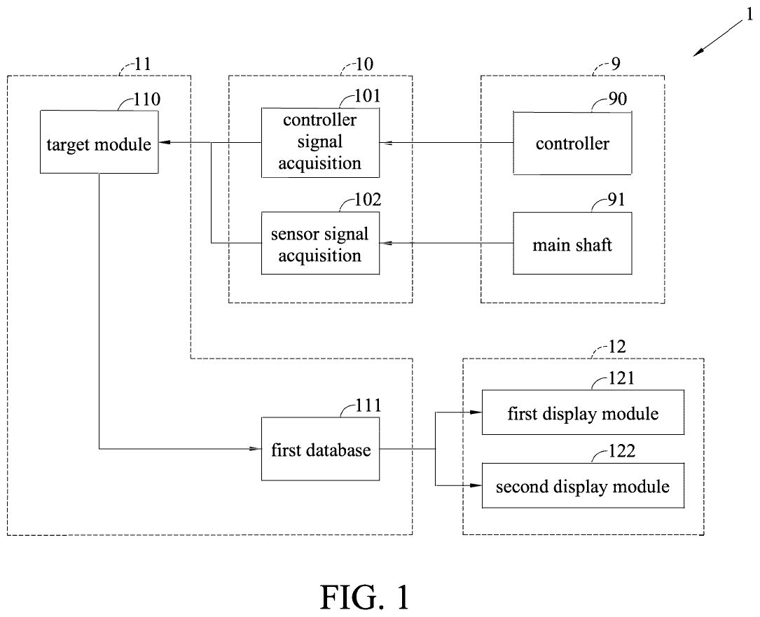

FIG. 1 is a schematic diagram of an architecture configuration of a machine tool diagnosis system 1 of the present disclosure. As shown in FIG. 1, the machine tool diagnosis system 1 comprises: an acquisition module 10, an analysis module 11 and an interaction module 12, but the present disclosure does not limit the possible integration, replacement, or increase or decrease configuration of each component of the above-mentioned architecture configuration.

In an embodiment, the machine tool diagnosis system 1 is applied to a machine tool 9 controlled by a computer numerical control (CNC), and the machine tool 9 processes a target machining object (not shown), wherein the machine tool 9 is configured with a controller 90, a sensor (accelerometer, microphone, displacement meter, speedometer, or other types of sensors that can sense vibration and sound signals, etc.), a programmable logic controller (PLC) and a main shaft 91 for configuring cutting tools, and can be connected externally with a data acquisition system (DAQ or DAS). The machine tool diagnosis system 1 is for example a standard configuration of the machine tool 9 or an independent computer (such as a remote computer, a personal computer, a tablet, or a mobile phone, etc.) and has functions of calculating and displaying diagnosis results.

The acquisition module 10 is used to acquire a plurality of machining signals, for example, acquiring machining parameter data (such as a first acquisition module 101) currently from the controller 90, sensing data (such as a second acquisition module 102) measured by sensor (such as accelerometer, microphone, or DAQ) on the main shaft 91 and/or others, etc.

In an embodiment, the acquisition method of the acquisition module 10 can be an internal direct transmission (for example, the machine tool 9 has the configuration of the machine tool diagnosis system 1), an application program interface (for example, to obtain the internal information of the controller 90), a programmable logic controller (PLC) used for transmission and temporarily storage of internal and external signals of the controller 90, an external device direct transmission (for example, encoders transmit coordinate signals, optical rulers transmit coordinate signals, data acquisition cards transmit coordinates, and control commands), etc.

Therefore, the acquisition module 10 may include a sensor for mounting on the main shaft 91 for the cutting tools, and can be connected to the controller 90 to accurately acquire the machining signals during machining, so as to measure and record a machining status (such as vibration signals during machining process) via the sensor (such as vibration sensor, displacement device, etc.) installed on the main shaft 91 of the machine tool 9 and collect the data (such as work coordinate position, machining rotation speed, feed speed, machining load, etc.) of the controller 90 of the machine tool 9 at the same time.

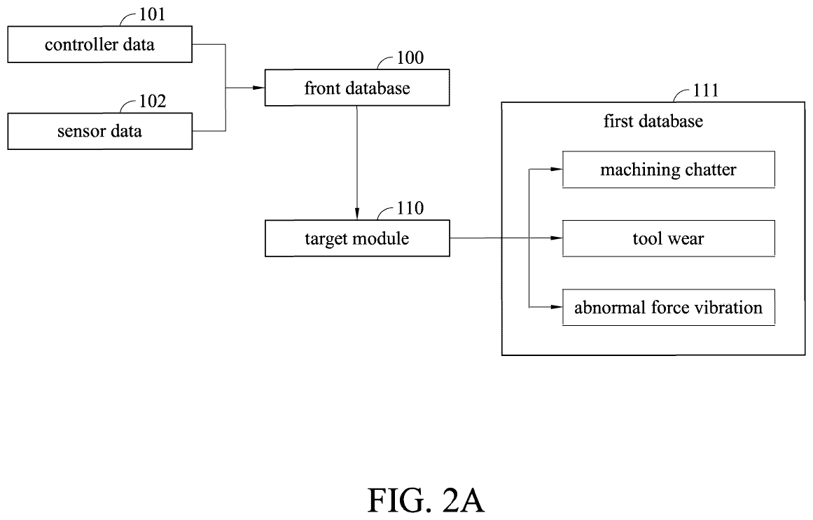

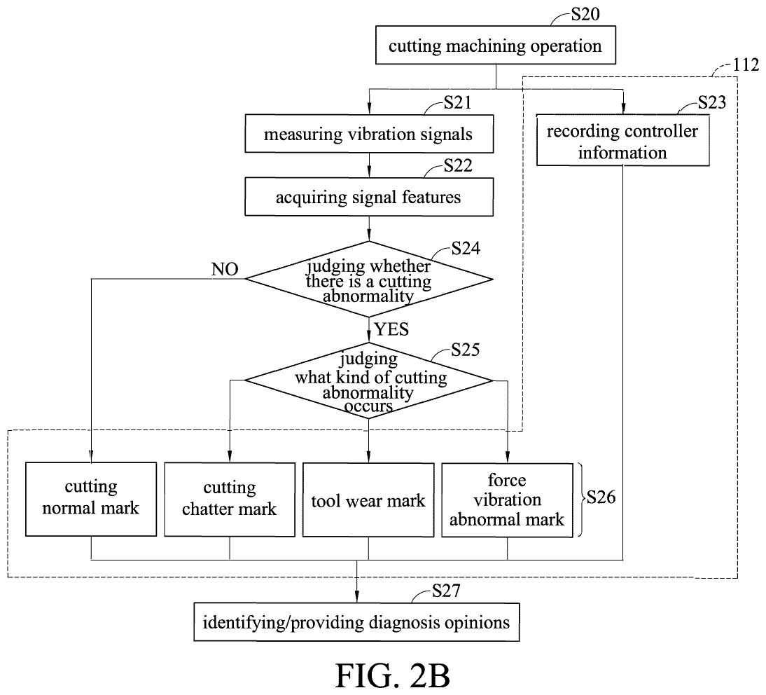

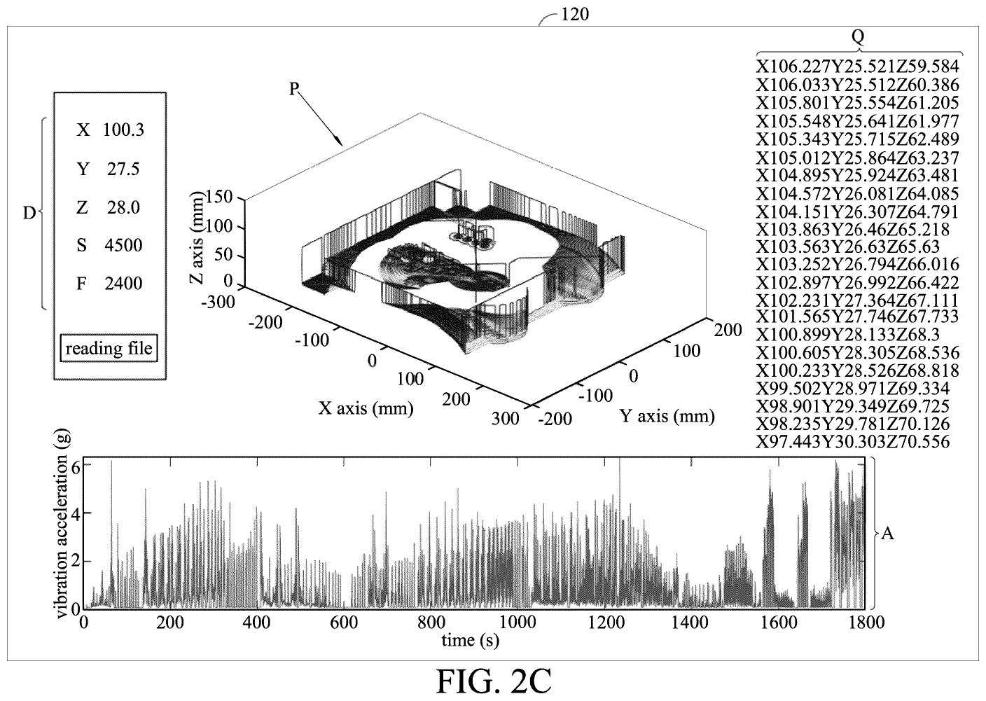

Furthermore, the acquisition module 10 can perform a feature acquisition operation on the machining signals of the first acquisition module 101 and the second acquisition module 102, as shown in FIG. 2A, so as to analyze the features of these machining signals, and then acquire machining signals of the required signal feature type, and then store the data (including sensor data and controller data) of the machining signals corresponding to the signal feature types in a front database 100 for use by the analysis module 11. For example, the signal feature type includes at least one of time domain features (values such as root mean square [RMS], kurtosis, spectral kurtosis, randomness, or other parameters, etc.), frequency domain features (frequency domain analysis using Fourier transform methods such as Fast Fourier Transform), and time-frequency domain features.

The analysis module 11 is communicatively connected to the acquisition module 10 (or the front database 100) to receive and process the plurality of machining signals, as shown in FIG. 2A, so as to obtain target information, and store the target information in a first database 111, wherein the analysis module 11 includes a target module 110 for processing the plurality of machining signals, and the object information includes processing results and diagnosis opinions.

In an embodiment, a construction process of the target module 110 is divided into a feature selection operation and a training operation. For example, a cutting machining operation (as shown in step S20) shown in FIG. 2B is used for description.

The feature selection operation is to perform feature analysis (e.g., acquisition signal feature as shown in step S22) on the measured machining signals (e.g., vibration signals as shown in step S21) to obtain the required signal feature type, which includes at least one of time domain features (values such as RMS, kurtosis, spectral kurtosis, or other parameters, etc.), frequency domain features (frequency domain analysis by Fast Fourier Transform method), and time-frequency domain features, etc. Moreover, a correlation analysis is used to filter and select the features of the machining signals with high correlation corresponding to the machining process conditions (such as machining chatter, tool wear and force vibration, etc.), for subsequent matching and integration actions (as shown in step S24 to step S25) with the data of the abnormal machining conditions and the information recorded by the controller 90 (as shown in step S23), so as to obtain reference data and store it in the target module 110 (a second database 112) for identification and diagnosis.

It should be understood that there are various ways of the correlation analysis, and there is no special limitation, as long as the features of the machining signals with high correlation corresponding to the machining process conditions can be filtered and selected.

The training operation is to use the artificial intelligence (AI) method to use the reference data of the second database 112 as training data to establish the target module 110, as shown in step S26 to step S27. For example, the artificial intelligence method adopts a supervised learning method, such as a convolutional neural network (CNN) model or other machine learning models, to perform machine learning and classification. Further, the CNN model is trained with the reference data to classify and mark the plurality of machining signals into four states including a normal state, a machining chatter state, a tool wear state and a force vibration abnormal state, etc.

Therefore, in the machining operation such as cutting, the machining signals conforming to the signal feature type are input to the target module 110, as in step S27, the target module 110 will identify based on whether different machining conditions (respectively machining chatter, tool wear and sensor values) are abnormal, so as to provide diagnosis opinions for the marked processing results. For example, if the processing result is that machining chatter occurs, then the diagnosis opinion is to adjust the machining rotation speed.

The interaction module 12 is communicatively connected to the analysis module 11, so that the target information generated by the target module 110 (or stored in the first database 111) is presented on a display interface 120 such as a computer screen (as shown in FIG. 2C), wherein the interaction module 12 includes a first display module 121 for displaying the processing results and a second display module 122 for displaying the diagnosis opinions, as shown in FIG. 1.

In an embodiment, a user manual selection is used for illustration. The first display module 121 presents a machining path P of the target machining object in a graphical manner according to a processing result A of the target information, so that when the user selects the machining path P of the processing result A, the second display module 122 will display parameter information Q (such as rotational speed data) and a diagnosis opinion D corresponding to the machining path P. For example, the interaction module 12 will read the processing result A of the first database 111, and draw a moving path of the tool tip point of the cutting tool in a three-dimensional drawing manner.

It should be understood that the present disclosure is not limited to manual selection by the user. In another embodiment, automation may be employed. For example, an area where the machining accuracy is particularly important to the machine tool 9 is pre-set, so that the parameter information Q and the diagnosis opinion D of the set area are automatically analyzed and displayed, and the machining part or area can be arbitrarily selected as a target area, such as the part where the curvature of the workpiece changes, the area with special requirements for machining accuracy, or other areas of interest, etc., and it is not limited to the area where abnormalities occur.

Therefore, if a user manual selection method is employed, when using the machine tool diagnosis system 1, the user first performs cutting measurement for the machining process such as the cutting process, and turns on the machine tool diagnosis system 1 to record the machining process, so that the interaction module 12 reads the measured record file to draw a moving path of the tool tip. Therefore, the user can click on the target area of the machining path P of the target machining object (such as the abnormal occurrence area) according to the needs. At this time, the interaction module 12 will display the diagnosis opinion D for the user to adjust the machine according to the diagnosis opinion (such as changing the machining rotation speed, adjusting the feed speed, or others).

As can be seen from the above, the machine tool diagnosis system 1 of the present disclosure can provide a visualization platform with a process diagnosis mechanism, so as to acquire the machining signals, analyze the machining signals and judge whether an abnormal situation occurs (such as excessive force vibration, cutting chatter, tool breakage, etc.), and present machining images and adjusting opinions on the display interface 120. Therefore, compared with the prior art, the operator can face the abnormal situation from the machining path P of the processing result A during the product proofing operation or the machining process, and adjust the machine according to the diagnosis opinion D. As a result, parameters and engineering methods can be quickly tested to greatly reduce production costs. It should be understood that the present disclosure is not limited to manual selection by the user. In another embodiment, automation may be employed. For example, an area where the machining accuracy is particularly important to the machine tool 9 is pre-set, so that the parameter information Q and the diagnosis opinion D of the set area are automatically analyzed and displayed, and the machining part or area can be arbitrarily selected as a target area, such as the part where the curvature of the workpiece changes, the area with special requirements for machining accuracy, or other areas of interest, etc., and it is not limited to the area where abnormalities occur.

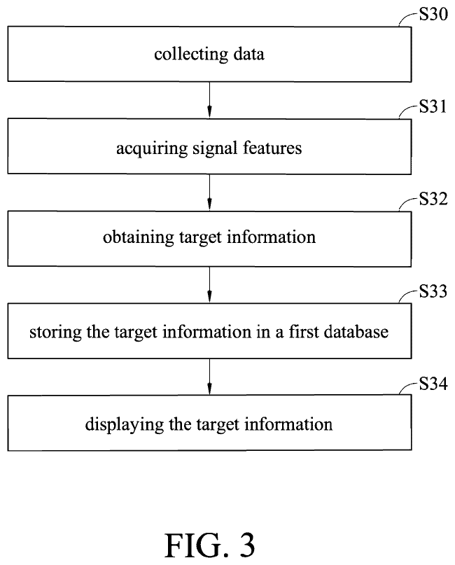

FIG. 3 is a flowchart illustrating the machine tool diagnosis method according to the present disclosure. In an embodiment, the machine tool diagnosis method is operated with the machine tool diagnosis system 1.

In step S30, data collection is performed by the acquisition module 10 to obtain a plurality of machining signals.

In an embodiment, the acquisition module 10 collects various relevant data measured by the machine tool 9 during machining. Therefore, the type of the plurality of machining signals can be, for example, the machining parameter data currently from the controller 90, the PLC state from the machine tool 9, and sensing data measured by sensors on the main shaft 91, or other required data, and is not limited to the above.

In step S31, the machining signals matching the signal features are filtered and selected by the acquisition module 10.

In an embodiment, the various relevant data collected in step S30 are subjected to feature analysis to filter and select the machining signals of the required signal feature type, and then stored in the front database 100 of the acquisition module 10.

In step S32, the target module 110 of the analysis module 11 processes the machining signals filtered and selected by the acquisition module 10 to obtain target information, wherein the target information includes the processing results and the diagnosis opinions.

In an embodiment, the target information can be stored in the first database 111 (such as step S33).

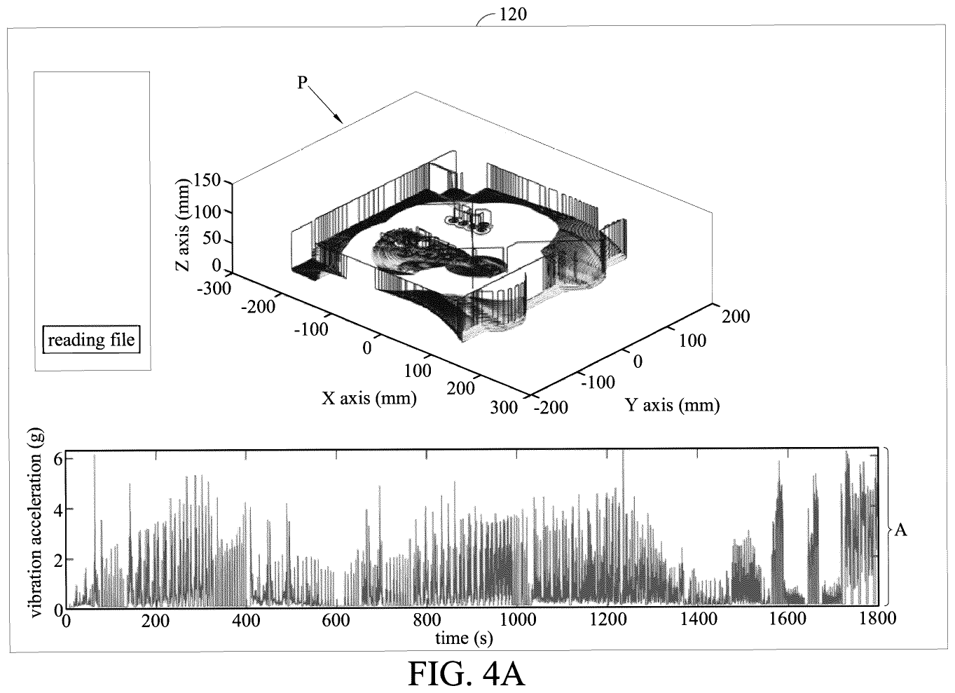

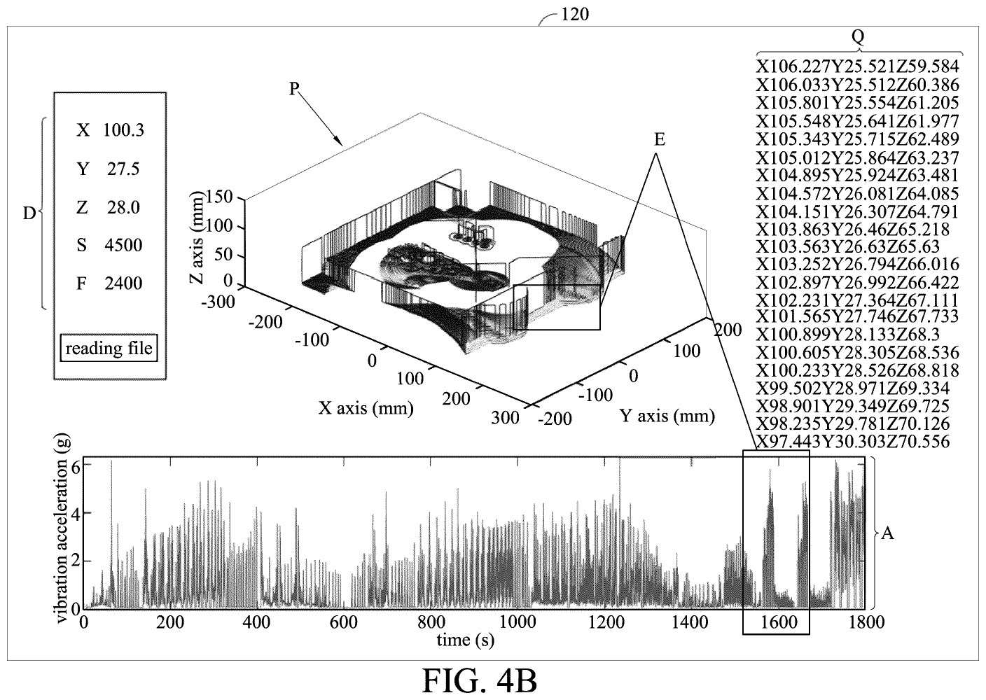

In step S34, the target information generated by the target module 110 (or stored in the first database 111) is presented on the display interface 120 such as a computer screen by the interaction module 12, as shown in FIG. 4A.

In an embodiment, the user clicks a target area E (such as the abnormal occurrence area) of the machining path P in the processing result A shown in FIG. 4A. As shown in FIG. 4B, the interaction module 12 will display the corresponding parameter information Q (such as rotational speed data) and the diagnosis opinion D of the target area E for the user to adjust the machining speed parameters of the target area E according to the diagnosis opinion D.

In summary, the machine tool diagnosis system and diagnosis method of the present disclosure use the design of the visualization platform to display (automatically set or manually select) the local area in the machining process as the target area (such as the abnormal area or the area of interest), for the user to know the parameter information and diagnosis opinions of the local area, so as to judge whether to perform follow-up actions such as adjustment of the machining process.

The foregoing embodiments are used for the purpose of illustrating the principles and effects rather than limiting the present disclosure. Anyone skilled in the art can modify and alter the above embodiments without departing from the spirit and scope of the present disclosure. Therefore, the range claimed by the present disclosure should be as described by the accompanying claims listed below:

What is claimed is:

1. A machine tool diagnosis method for applying to a machine tool configured with a controller and a main shaft, the machine tool diagnosis method comprising:
acquiring a plurality of machining signals of the controller and the main shaft when the machine tool processes a target machining object;
processing the plurality of machining signals via a target module to obtain target information, wherein the target information includes processing results and diagnosis opinions;
graphically presenting a machining path of the target machining object on a display interface according to the processing results; and
displaying the diagnosis opinions corresponding to the machining path by the display interface.

2. The machine tool diagnosis method of claim 1, wherein the plurality of machining signals are obtained by an acquisition module from machining parameter data from the controller and sensing data measured by sensors on the main shaft.

3. The machine tool diagnosis method of claim 1, further comprising performing a feature acquisition operation on the plurality of machining signals to acquire machining signals of required signal feature type for processing by the target module.

4. The machine tool diagnosis method of claim 1, wherein the target module is a machine learning model.

5. The machine tool diagnosis method of claim 1, wherein the display interface further displays parameter information corresponding to the machining path.

6. A machine tool diagnosis system for applying to a machine tool configured with a controller and a main shaft, the machine tool being used to process a target machining object, the machine tool diagnosis system comprising:
an acquisition module configured for acquiring a plurality of machining signals of the controller and the main shaft;
an analysis module communicatively connected to the acquisition module to receive and process the plurality of machining signals, wherein the analysis module includes a target module for processing the plurality of machining signals to obtain target information, and the target information includes processing results and diagnosis opinions; and
an interaction module communicatively connected to the analysis module to graphically present a machining path of the target machining object on a display interface according to the processing results, wherein the display interface further displays the diagnosis opinions corresponding to the machining path.

7. The machine tool diagnosis system of claim 6, wherein the acquisition module includes a first acquisition module for acquiring machining parameter data from the controller, and a second acquisition module for acquiring sensing data measured by sensors on the main shaft.

8. The machine tool diagnosis system of claim 6, wherein the acquisition module performs a feature acquisition operation on the plurality of machining signals to acquire machining signals of required signal feature type for processing by the analysis module.

9. The machine tool diagnosis system of claim 6, wherein the target module is a machine learning model.

10. The machine tool diagnosis system of claim 6, wherein the interaction module further displays parameter information corresponding to the machining path.
